(19) United States
(12) Patent Application Publication
(10) Pub. No.: US 2003/0080986 A1
(43) Pub. Date: May 1, 2003

(54) System and method for accessing and utilizing remote bookmark lists

(76) Inventor: Roger T. Baird, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/004,368

(22) Filed: Nov. 1, 2001

(51) Int. Cl. G06F 7/00

(52) U.S. Cl. 345/700

(57) ABSTRACT

A Web browser includes a group bookmarks feature allowing accessing and displaying groups of bookmarks from at least one remote location (location(s) remote from the local computer system upon which the Web browser is running). The groups of bookmarks may be groups stored in at least one files accessible in a directory on a remote computer system that is coupled to the user's local computer system via a network. Alternatively, the groups of bookmarks may be part of a Web page that is accessible from the local computer system.

### TECHNICAL FIELD

The invention relates generally to information retrieval in a computer network. More particularly, it is related to a system and method for improved accessing of Web pages on a global computer network such as the Internet.

### BACKGROUND ART

The Internet is a well-known worldwide collection of networks and gateways that allow communications between computers via high-speed data communication lines between major nodes or host computers. The Internet allows users to access the World Wide Web (“the Web”). The Web is a set of interlinked hypertext documents residing on servers all around the world. Documents on the Web, known as Web pages, may be written in HTML (hypertext markup language), and are identified by URLs (uniform resource locators) that specify the particular machine and path name by which a file may be accessed and/or transferred from server to end user. Web pages may contain tags that allow users to link to other Web pages. Web pages are accessed and displayed through use of user software such as a Web browser. Examples of Web browsers are Netscape Navigator and Microsoft Internet Explorer.

One of the features of Web browsers is a list of “bookmarks” or “favorites.” Such a list may also be referred to as a “hot list.” This feature allows a user to store a link to a Web page or other URL in a local file. Bookmark lists allow users to bypass the difficult task of manually entering URLs for frequently-accessed Web pages. The user may add bookmarks to his or her list by accessing a selection on a menu, for example, an “add bookmarks” selection on a bookmarks menu. This set of actions adds the URL of the current Web page as an item in the bookmarks menu. Additional information, such as the title of the Web page, may also be stored, thus enabling the bookmarks to be conveniently identified and accessed.

Current methods of sharing bookmarks between users include e-mailing files containing bookmarks or links, and downloading special files containing information regarding the links that are available on a particular Web site. Such methods may require significant user effort, for example in accessing links in an e-mail message, and saving them to the user's bookmarks list. Also, such methods may involve additional effort by Web site content providers, for creating and maintaining special files containing local link information.

### SUMMARY OF THE INVENTION

A system for network navigation enables automatic accessing and display in a bookmarks list of at least one group of bookmarks stored on a remote computer system.

According to an aspect of the invention, a method of network navigation using a computer system includes displaying a group indicator associated with at least one bookmark group that includes a number of group-associated bookmarks that are maintained on a remote computer system; accessing a locator for each of the group-associated bookmarks from the remote computer system, upon an occurrence of a selecting action directed at the group indicator; and displaying a number of bookmark indicators, each of the bookmark indicators being associated with a respective one of the group-associated bookmarks.

According to another aspect of the invention, a computer program embodied in a computer readable medium, for network navigation, includes code that displays a group indicator associated with at least one bookmark group that includes a number of group-associated bookmarks that are maintained on a remote computer system; code that a locator for each of the group-associated bookmarks from the remote computer system, upon an occurrence of a selecting action directed at the group indicator; and code that displays a number of bookmark indicators, each of the bookmark indicators being associated with a respective one of the group-associated bookmarks.

According to yet another aspect of the invention, a system for network navigation includes a processor coupled to a local interface; a memory coupled to a local interface; and processing logic stored on the memory and executable by the processor. The processing logic includes logic that displays a group indicator associated with at least one bookmark group that includes a number of group-associated bookmarks that are maintained on a remote computer system; logic that accesses a locator for each of the group-associated bookmarks from the remote computer system, upon an occurrence of a selecting action directed at the group indicator; and logic that generates a display that includes a number of bookmark indicators, each of the bookmark indicators being associated with a respective one of the group-associated bookmarks.

According to still another aspect of the invention, a system for network navigation includes means for displaying a group indicator associated with at least one bookmark group that includes a number of group-associated bookmarks that are maintained on a remote computer system; means for accessing a locator for each of the group-associated bookmarks from the remote computer system, upon an occurrence of a selecting action directed at the group indicator; and means for displaying a number of bookmark indicators, each of the bookmark indicators being associated with a respective one of the group-associated bookmarks.

According to a further aspect of the present invention, a method of network navigation using a computer system includes: displaying a group indicator associated with at least one bookmark group that includes a number of group-associated bookmarks that are maintained on a remote computer system; accessing a locator for each of the group-associated bookmarks from the remote computer system, upon an occurrence of a selecting action directed at the group indicator; and displaying a number of bookmark indicators, each of the bookmark indicators being associated with a respective one of the group-associated bookmarks. The accessing includes downloading a web page from the remote computer; and parsing source code of the web page to extract the locators. The parsing includes: extracting the bookmark indicators from the source code; examining the source code for anchor tags; and extracting text from the anchor tags for the bookmark indicators.

To the accomplishment of the foregoing and related ends, the invention comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

The invention can be understood with reference to the following drawings, which are not necessarily to scale. Also, in the drawings, like reference numerals designate corresponding parts throughout the several views.

FIG. 1 is a block diagram of a network navigation system according to the an embodiment of the present invention;

FIG. 2 is a representation of a graphical user interface displayed using the network navigation system of FIG. 1;

FIG. 3 is a representation of alternative graphical user interface displayed using the network navigation system of FIG. 1;

FIG. 4 is a flowchart of high-level functionality of the network navigation system of FIG. 1;

FIG. 5 is a flowchart of some of the functionality of the bookmark retrieval of FIG. 4; and

FIG. 6 is a flowchart of some of the functionality of the source code parsing of FIG. 5.

### DETAILED DESCRIPTION

A Web browser includes a group bookmarks feature allowing accessing and displaying groups of bookmarks from one or more remote locations (locations remote from the local computer system upon which the Web browser is running). The groups of bookmarks may be groups stored in one or more files accessible in a directory on a remote computer system that is coupled to the user's local computer system via a network. Alternatively, the groups of bookmarks may be part of a Web page that is accessible from the local computer system.

The group bookmarks feature allows users to conveniently share bookmarks. Further, the group bookmarks feature facilitates easy updating of bookmarks of interest to a specified group of people. For instance, providing a new link to employees of a company for accessing certain information, such as payroll information, may be accomplished by adding a new bookmark to the shared group bookmark file, directory, or page. This process is faster, simpler, and less prone to error than an alternative such as e-mailing the new link to all employees.

Another advantage of the group bookmarks feature is that it allows for easy removal of links that have become outdated or are otherwise no longer active. For example, a link to information about a meeting may be removed from a remote bookmark group location after the meeting has ended. Thus subscribers or users of the group of bookmarks may be able to access the link when it is relevant, without having to delete a bookmark when it is outdated. This results in a savings of time and effort for computer users, and makes for a more pleasant browsing experience.

The Web browser may display group-associated bookmarks upon a selecting action (e.g., hovering or right-clicking). The selecting action may be a trigger causing the Web browser to download the Web page corresponding to the indicated bookmark group (“bookmark group page”). The downloaded bookmark group page may then be parsed to gather information on the links (group-associated bookmark locators) that are included in the bookmark group page. Text associated with the links, such as an anchor tag hyperlink text, may also be extracted from the bookmark group page and used as bookmark indicators corresponding to the group-associated bookmarks. The bookmark indicators associated with the group-associated bookmark locators are then displayed.

The display of the group indicators may be in a separate menu. Alternatively, the display of the group indicators may be in a submenu off of a menu or list of bookmarks maintained on the local computer. For example the group indicators may be displayed adjacent to a folder on the bookmarks list that corresponds to bookmark groups.

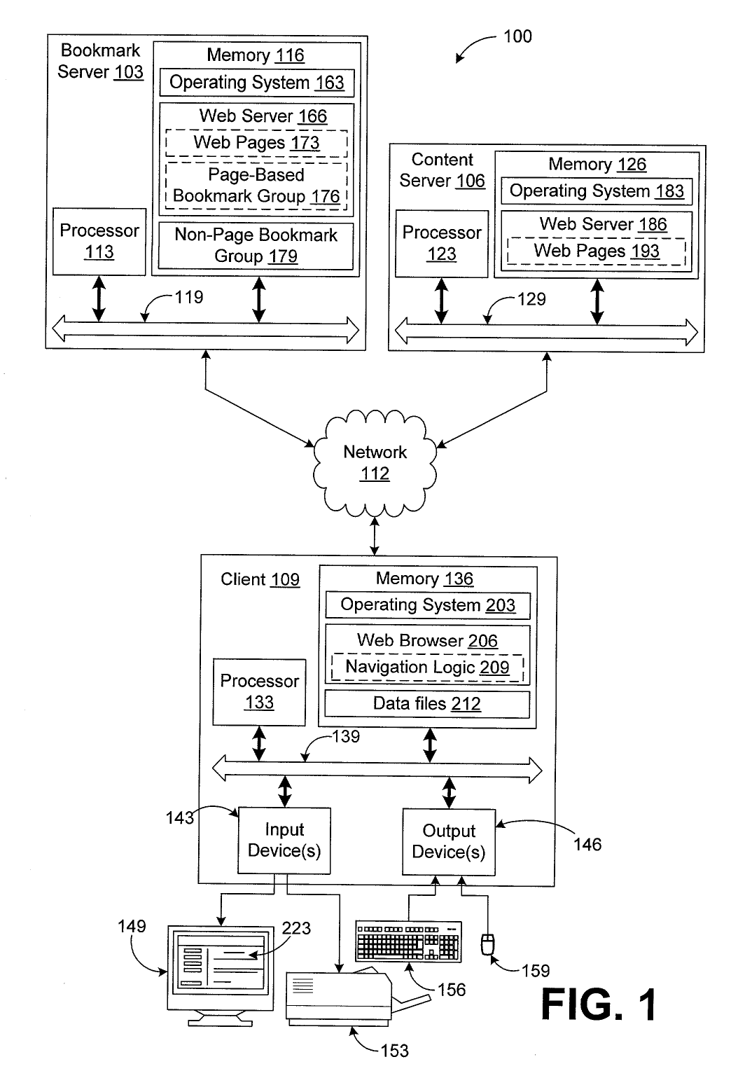

Referring initially to FIG. 1, a network navigation system 100 is shown. The network navigation system includes a bookmark server 103, a content server 106, and a client 109. Both the bookmark server 103 and the content server 106 are coupled to the client 109 via a network 112. The servers 103 and 106 may each include, for example, a computer system or other apparatus with similar capability. In particular, the bookmark server 103 includes a processor circuit with a processor 113 and a memory 116, both of which are coupled to a local interface 119. Similarly, the content server 106 includes a processor circuit with a processor 123 and a memory 126, both of which are coupled to a local interface 129. The local interfaces 119 and 129 each may include, for example, a data bus with an accompanying control/address bus, as is generally known by those with ordinary skill in the art.

Various peripheral devices may be employed with the servers 103 and 106. In particular, peripheral devices to obtain user input may include, for example, a keypad, touchpad, touch screen, microphone, scanner, mouse, joystick, or one or more push buttons, etc. Peripheral devices providing user output may include display devices, indicator lights, speakers, printers, etc. Specific display devices may be, for example, cathode ray tubes (CRTs), liquid crystal display (LCD) screens, light emitting diode (LED) displays, gas plasma-based flat panel displays, etc.

The content server 106 is intended to represent one of a plurality of servers coupled to the client 109 via the network 112, which for example provide content to be downloaded or otherwise transferred to the client 109. The bookmark server 103 may also be a server that provides content that may be downloaded or transferred to the client 109.

The client 109 may include, for example, a computer system or other system with similar capability. In particular, the client 109 includes a processor circuit with a processor 133 and a memory 136, both of which are coupled to a local interface 139. The local interface 139 may be, for example, a data bus with an accompanying control/address bus, as is generally known by those with ordinary skill in the art. The client 109 also includes various output interfaces 143 and input interfaces 146, through which the client 109 may be connected to various peripheral devices. Such peripheral devices may include a display device 149, a printer 153, a keyboard 156, and a mouse 159. Other peripheral devices that may be employed by the client 109 to receive various user input and/or to provide user output include those listed above with regard to the server 103.

The memories 116, 126, and 136 may include both volatile and nonvolatile memory and data storage components. Volatile components are those that do not retain data values upon loss of power. Nonvolatile components are those that retain data upon a loss of power. Thus, the memories 116, 126, and 136 may comprise, for example, random access memory (RAM), read-only memory (ROM), hard disk drives, floppy disks accessed via an associated floppy disk drive, compact discs accessed via a compact disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other such of memory device.

Also, each of the processors 113,123, and 133 may represent multiple processors and each of the memories 113, 123, and 133 may represent multiple memories that operate in parallel processing circuits, respectively. In such a case, each of the local interfaces 119,129, and 139 may be an appropriate network that facilitates communication between any two of the multiple processors, between any processor and any of the memories 116, 126, and 136, or between any two of the memories, etc. The processors 113, 123, and 133 may be electrical or optical in nature.

The network 112 includes, for example, the Internet, wide area networks (WANs), local area networks, or other suitable networks, etc., or any combination of two or more such networks. The servers 103 and 106, and the client 109, is coupled to the network 112 to facilitate data communication to and from the network 112 in any one of a number of ways that are generally known by those of ordinary skill in the art. In this respect, the servers 103 and 106, and/or the client 109, may be linked to the network 112 through various devices such as, for example, network cards, modems, or other such communications devices.

The bookmark server 103 includes various software components that are stored on the memory 116 and are executable by the processor 113. These components include an operating system 163 and a Web server 166 are stored on the memory 116. The Web server 166 includes one or more Web pages 173. In addition, the bookmark server includes one or more bookmark groups. The bookmark groups may include a page-based bookmark group 176 that may be included in or may otherwise be a part of one of the Web pages 173. Alternatively or in addition, the bookmark groups may include a non-page bookmark group 179 that is not part of or linked to the Web pages 173. For example, the non-page bookmark group 179 may be one or more files in a specified directory.

The page-based bookmark group 176 may be included in the code of the corresponding Web page 173. Alternatively, the bookmark group 176 may be one or more files separate from the corresponding Web page 173, but linked to the corresponding Web page 173. The one or more separate files may be linked to the corresponding Web page 173 by well-known methods, such as be call-outs in the source code of the corresponding Web page.

The content server 103 also includes various software components that are stored on the memory 126 and are executable by the processor 123. These components include an operating system 183 and a Web server 186 are stored on the memory 126. The Web server includes one or more Web pages 193.

The client 109 also includes a number of software components that are stored on the memory 136 and are executable by the processor 133. These components include an operating system 203 and a Web browser 206. By manipulating the browser 206, the pages 173 and 193 may be downloaded from the servers 103 and 106, having been transmitted by the appropriate of the Web servers 166 and 186, stored on the respective memories 116 and 126 of the servers 103 and 106. Thus, the browser 206 and the Web servers 166 and 186 may operate according to the dictates of the World Wide Web protocol, for example, or another suitable protocol. In this sense, the Web pages 173 and 193 may be created using hypertext markup language (HTML), as is generally known by those with ordinary skill in the art. Alternatively, other programming languages may be employed to create the Web pages 173 and 193, including Extensible Markup Language (XML) or another markup language, JAVA, Active Server Page Scripting (ASP), JavaScript, C++, or other suitable computer languages. It will also be appreciated that the pages 173 and 193 may include other types of pages and/or data files.

The memory 136 also includes navigation logic 209 and data files 212. The navigation logic 209, which may be part of the Web browser 206, aids in navigation through various Web pages accessible through the network 112. The navigation logic 209 may facilitate navigation to and through the bookmarks included in the bookmark groups 176 and 179. The data files 212 may include data regarding links found in the bookmark groups 176 and 179, as explained in greater detail below.

Each of the operating systems 163,183, and 203 are executed to control the allocation and usage of hardware resources in the servers 103 and 106 and the client 109, respectively. Specifically, the operating systems 163, 183, and 203 control the allocation and usage of the memory 116, 126, and 136, processing time, and the peripheral devices as well as performing other functionality. In this manner, the operating systems 163, 183, and 203 serve as the foundation on which applications depend as is generally known by those with ordinary skill in the art.

In addition, the processor 133 of the client 109 may execute the Web browser 206 to interpret one or more of the Web pages 173 and 193 downloaded form the servers 103 and 106. Based on the Web pages 173 and 193, the browser 206 generates corresponding graphical user interfaces (GUIs) 223 on the display device 149, which may be manipulated by the user of the client 109.

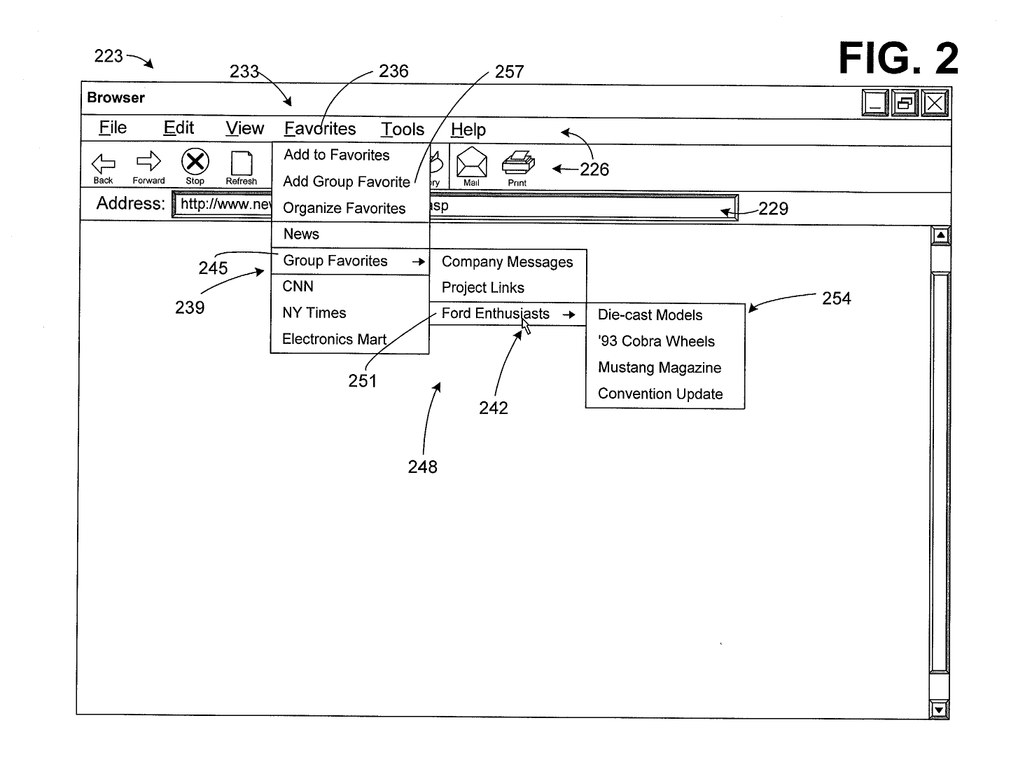

With reference now to FIG. 2, an illustration is shown of the graphical user interface (GUI) 223 according to an aspect of the present invention. The graphical user interface 223 shows various browser components 226, as well as an address box 229 that may be manipulated to access various of the Web pages 173 and 193 (FIG. 1) on various servers 103 and 106 (FIG. 1) coupled to the network 112 (FIG. 1). Specifically, a user may enter a uniform resource locator (URL) in the address box 229 to address a specific Web page 193 located at a specific content server 106.

The browser components 226 include a bookmark feature 233. The bookmark feature 233 includes a bookmark activator 236 for actuating a bookmark menu 239. The activator 236 may be actuated by clicking on a specified area of the GUI 223, for example, by moving a cursor 242 to the specified area and performing a specified task, such as clicking a button. The cursor 242 may be moved by a mouse, trackball, or other pointing device, or may be moved by use of one or more keyboard commands. Actuation to display the pull-down menu 239 may be accomplished by clicking a button on the mouse or trackball, or by pressing a specified key on the keyboard. It will be appreciated that other methods of activating a pull-down menu are possible. For example, a touch screen may be employed. Alternatively, a series of keyboard commands, for example utilizing control and/or escape keys, may be used. As another alternative, devices such as light pens may be employed to activate the bookmarks menu 239. Also, other types of GUI mechanisms will be known to one skilled in the art. Examples are well-known devices such as drop-down menus and trees.

The navigation logic 209 includes logic to access the bookmark groups 176 and/or 179, and to display the bookmarks cited therein on the GUI 223. For example, when a selecting action is performed on a bookmark group entry 245 of the bookmark menu 239, a bookmark group submenu 248 is displayed. The bookmark group submenu 248 displays a list of bookmark groups that are available for access and display by the navigation logic 209.

Performing a selecting action on a bookmark group indicator 251 of the bookmark group submenu 248 causes display of a group-associated bookmark submenu 254. The group-associated bookmark submenu displays a list of bookmark indicators corresponding to the bookmarks that are part of the selected bookmark group. The browser 206 accessing the corresponding group from the bookmark groups 176 and/or 179 on the bookmark server 103. Information on the bookmarks in the corresponding group may be downloaded to the client 109, and is used to create and display the group-associated bookmark submenu 254. The downloaded information may include URLs for the bookmarks as well as identifying text (such as a title of the bookmarked page). The user of the client 109 may select from the bookmarks of the group-associated bookmark submenu 254 in order to access the Web pages corresponding to the links. The corresponding bookmarked pages Web pages may be Web pages 193 on the content server 106, and/or may be Web pages 173 on the bookmark server 103.

The selecting action(s) for actuating display of the bookmark group submenu 248 and the group-associated bookmark submenu 254 may be any of a variety of suitable actions. For example, a selecting action may involve simply moving the cursor 242 atop the text of the bookmark group entry 245 or the bookmark group indicator 251, or in an area corresponding to the bookmark group entry 245 or the bookmark group indicator 251. Alternatively, the selecting action may involve “hovering” (maintaining the cursor 242 in an corresponding area for a specified period of time). As another alternative, the selecting action may involve clicking a button, such as a button on a mouse or trackball, while in the corresponding area of the GUI 223 corresponding to the bookmark group entry 245 or the bookmark group indicator 251. Such clicking may involve a single click, such as clicking a right-hand mouse button, or may involve multiple clicks, such as double-clicking a mouse button, or clicking two mouse buttons at the same time. As another alternative, selecting action may include pressing one or more keys on a keyboard. The selecting action for actuating display of the bookmark group submenu 248 may be the same as, or different from, the selecting action for actuating display of the group-associated bookmark submenu 254. Multiple possible selecting actions may be utilized, any one of which will actuate the bookmark group submenu 248 or the group-associated bookmark submenu 254. It will be appreciated that other suitable selecting actions will be apparent to one skilled in the art.

The selecting action(s) for actuating the display of the bookmark group submenu 248 or the group-associated bookmark submenu 254 may be different from a second selecting action to cause the Web browser 206 to access and display on the GUI 223 a Web page 173 or 193 corresponding to an entry on the bookmarks list 239 or the group-associated bookmark submenu 254.

The data files 212 may contain information used in displaying the bookmark group submenu 248 and in accessing and downloading information from Web pages 173 corresponding to bookmark groups such as the group corresponding to the bookmark group indicator 251. For example, the data files 212 may include the indicators (group names or titles) such as the indicator 251. Also the data files will include an address or other locator used to access the group bookmarks. Such a locator may be a URL, or may be a file location such as the location of a shared directory.

The action of selecting the bookmark group indicator 251 for the displaying of the corresponding group-associated bookmark submenu 254 signal the client 109 to download the corresponding Web page 173 which contains the corresponding page-based bookmark group 176 and determine the links in the corresponding Web page. Thus, the selecting action may cause the client 109 to access the bookmark server 103 and download the Web page 173 that contains the corresponding page-based bookmark group 176. The corresponding Web page 173 may then be parsed by the navigation logic 209 to extract the links on that Web page, which are the links that correspond to the entries in the group-associated bookmark submenu 254. For example, the navigation logic 209 may search line by line through the source code of the corresponding Web page 173, searching for anchor tags. The Uniform Resource Locator (URL) of the tag may be extracted from the source code for use as a bookmark. That is, the URLs extracted from the anchor tags may be the links that correspond to the entries in the group-associated bookmark submenu 254. Also, identifying text associated with the link may be extracted, for example for use as the text in the group-associated bookmark submenu 254. The identifying text may be, for example, hyperlink text from the anchor tags. Thus the identifying text may be the text that would be displayed on the corresponding Web page 173 as a selectable hyperlink. This process of determining the links and the locators and text associated therewith, generally is referred to herein as “parsing.”

It will be appreciated that navigation logic 209 may be configured to sort the anchor tags found in the parsing process, displaying only certain of the links found in the tags. For example, when an anchor tag is found, the navigation logic 179 may make a determination as to whether the tag corresponds to a local link (a link within the same Web page) or a non-local link (a link outside the corresponding Web page). The navigation logic 179 may be configured to display only non-local logic in the group-associated bookmark submenu 254.

Many variants are possible on the parsing process described above. For example, the determining of the text (bookmark indicator) associated with a link (bookmark locator) may include downloading the Web page corresponding to the link, and extracting the title of the Web page for use as the associated identifying text. This downloading and extracting may be used as an alternative for situations in which there is no anchor tag text associated with a non-local link, for example when a non-local link corresponds to a graphic image.

It will be appreciated that the process of downloading the corresponding Web page 173 and parsing the corresponding Web page 173 to determine the links may be performed prior to the selecting action of selecting the bookmark group entry 245. For example, upon startup of the Web browser 206, the navigation logic 209 may be configured to download and parse all of the Web pages 173 corresponding to the bookmark group indicators listed in the submenu 248. The information on the links (the URLs or other locators and the associated identifying text) may be stored in the memory 136 of the client 109. In addition the navigation logic 209 may be configured to periodically re-download the Web pages 173 containing to the bookmark group indicators, to update the list of links.

It will further be appreciated that the selecting action of selecting the bookmark group entry 245 may itself be used to actuate updating of the bookmarks corresponding to the bookmark groups. For instance, selecting the bookmark group entry 245 may cause the bookmark group submenu 248 of the corresponding bookmarks to be displayed (using stored information on the groups), while at the same time causing the Web pages 173 corresponding to the bookmark groups to be downloaded and parsed. After the corresponding Web pages 173 have been downloaded and parsed, information regarding the group-associated bookmarks may be store and/or updated. It will be appreciated that retrieving information on regarding the group-associated bookmarks prior to the selection of any of the groups may improve performance time by allowing the group-associated bookmark submenu 254 to be displayed more quickly.

The Web pages corresponding to the entries in the group-associated bookmark submenu 254 may be directly selectable. For example, an entry in the group-associated bookmark submenu 254 may be selectable by movement of the cursor 242 onto an area corresponding to the entry, and performing a specified task, for example, left-clicking using a mouse button.

As another alternative, the identifying text displayed in the group-associated bookmark submenu 254 may be all or part of the URL of the corresponding Web page. It will be appreciated that there may be a hierarchical system for determining the identifying text to be displayed in the group-associated bookmark submenu 254. For example, the navigation logic 209 may be configured to display the hyperlink text in the anchor tag, if any. If there is no hyperlink text in the anchor tag, the navigation logic 209 may be configured such that the Web page corresponding to the link is downloaded, and the title of that Web page is extracted and used as the identifying text for the corresponding link. If neither of these steps results in obtaining identifying text, then the navigation logic 209 may utilize the URL of the link as the identifying text. It will be appreciated that only a portion of the URL may be utilized, and/or that the navigation logic 209 may be configured to truncate the identifying text if the URL exceeds a certain number of characters. It will be appreciated that other suitable methods of generating identifying text may be used.

The accessing of entries for listing in the group-associated bookmark submenu 254 has been described above largely in terms of downloading a corresponding Web page 173 parsing to extract information from the page-based bookmark groups 176. However, as noted above, some or all of the bookmarks of the group bookmarks may be in the non-page bookmark groups 179. It will be appreciated that such information may be downloaded or otherwise accessed by the client 109 in a number of suitable, well-known ways. For example, many suitable, well-known methods exist for having shared directories of files that are accessible over networks such as the network 112. The information in the files corresponding to the non-page bookmark groups 179 may be files of the same format or a similar format to bookmarks conventionally stored locally on the client 109 and used by the Web browser 206.

The bookmarks list 239 includes a selectable add group entry feature 257. The add group bookmarks entry feature enables the user of the client 109 to “subscribe” to a Web site or other source of group bookmarks. Actuating the selectable add group entry 257 feature may initiate an interactive process between the Web browser 206 and the user of the client 109, prompting the user to enter or otherwise indicate, for example, a location of a bookmark group, and a title or other indicator to be displayed to identify the bookmark group.

The GUI 223 has been shown in FIG. 2 and described above in terms of lists in the bookmark group submenu 248 and the group-associated bookmark submenu 254 adjacent to the bookmark group entry 245 and the bookmark group indicator 251, respectively. However, it will be appreciated that the other suitable arrangements may be used. For example, the bookmark group submenu 248 and/or the group-associated bookmark submenu 254 may be displayed in pop-up windows on other parts of the GUI 223. Alternatively, the information in the bookmark group submenu 248 and/or the group-associated bookmark submenu 254 may appear as part of the bookmark menu 239.

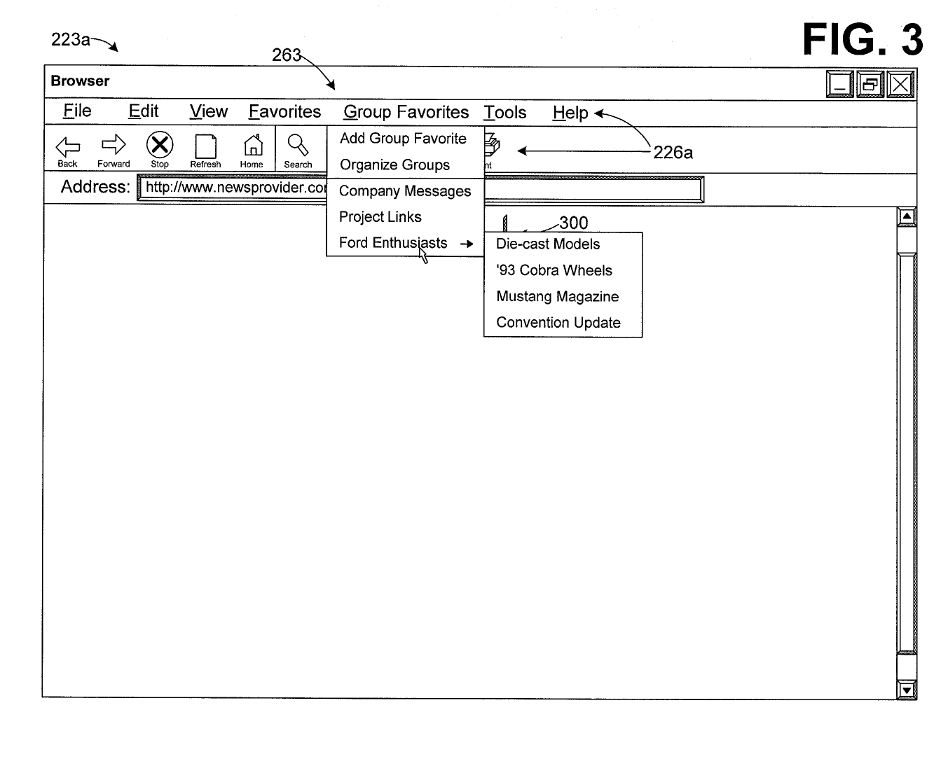

Another alternative arrangement of information is shown in FIG. 3, wherein a GUI 223a includes a group bookmarks feature 263 as a separate one of the browser components 226a.

It will be appreciated that some or all of the various features described above may be selectable by a user, for example, being selectable from a range of alternatives. For instance, the particular selecting action that causes the indicators corresponding to the bookmark groups and/or the group-associated bookmarks to be displayed may be selectable by the user of the client 109, from a range of possible alternatives.

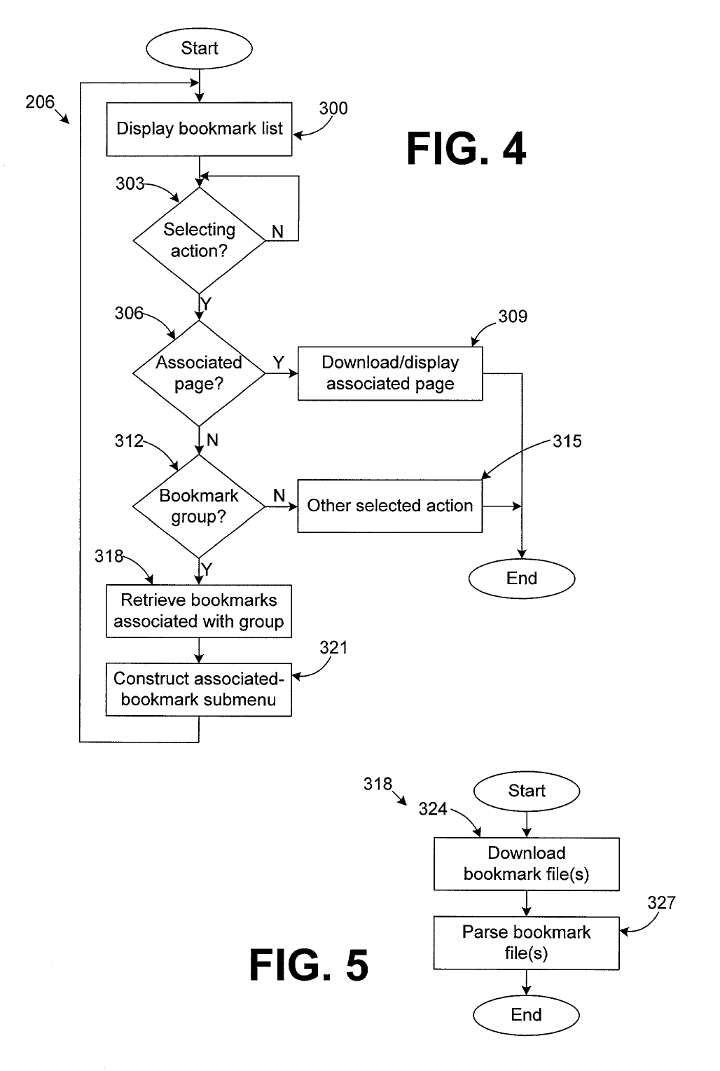

FIG. 4 shows a flowchart of the general functionality (logical function) of the Web browser 206 (FIG. 1), including the navigation logic 209 (FIG. 1) of the client 109 (FIG. 1). Alternatively, the flowchart of FIG. 4 may represent method steps taken in executing the Web browser 206, including the navigation logic 209. In block 300 a bookmark list, such as the bookmark menu 239 (FIG. 2), is displayed on the GUI 223 (FIG. 1). In block 303 the Web browser 206 awaits a selection action by the user of the client 109. When a selecting action is received by the Web browser 206, in block 306 the selecting action is examined to determine if it is a selection to download and display a Web page 173 or 193 (FIG. 1) corresponding to a bookmark on the bookmarks list 239. If so, in block 309 the associated Web page 173 or 193 is downloaded and displayed on the GUI 223. As part of the download and display process in block 309, the Web browser 206 stops displaying the bookmark menu 239. A common selecting action for downloading and displaying a Web page associated with a bookmark is by using a mouse to position a cursor on the text in the bookmark menu 239, and clicking a left mouse button. This method of selecting a Web page for display from a bookmarks menu is utilized in both Netscape Navigator and Microsoft Internet Explorer.

If the selecting action is not an action to select an associated page from the bookmarks menu 239, then in block 312 the selecting action is examined to determine whether it is a request to display the indicators corresponding to the bookmarks of one of the bookmark groups. An example is the group-associated bookmark submenu 254 shown in FIG. 2. If the selecting action is not for displaying a group-associated bookmark submenu 254, then in block 315 another action corresponding to the selecting action is performed. It will be appreciated that there are a wide variety of other actions that may be selected in the GUI 223. For example, moving the cursor 242 (FIG. 2) to an area not covered by the bookmark menu 239 or an associated submenu may result in the Web browser 206 ceasing display of the bookmarks menu 239. Alternatively, moving the cursor 242 to another one of the browser components 226 and performing a selecting action such as clicking a left mouse button may cause a different corresponding action. It will be appreciated that user actions such as keyboard commands may also cause other actions to be taken by the Web browser 206.

If the selecting action instructs the Web browser 206 to display the bookmarks associated with a group bookmarks list, in block 318 the bookmarks associated with the bookmark group are retrieved. Finally, in block 321 the group-associated bookmarks submenu 254 is constructed. The Web browser 206 then returns to block 300 to display the updated bookmark list, including the submenu.

It will be appreciated that the blocks shown in FIG. 4 are only one example of the possible range of actions taken in displaying a submenu or other list of links found in a Web page corresponding to a bookmarker favorite. It will be appreciated that the full range of other suitable methods/functions described above with regard to FIGS. 2 and 3 may be realized with suitable modifications of the flowchart shown in FIG. 4.

Turning now to FIG. 5, high-level details are shown of one possible embodiment of the block 318 retrieval of bookmarks associated with a bookmark group. In block 324, file(s) associated with the bookmark group are downloaded. The file(s) may include the corresponding Web page 173 containing the corresponding page-based group 176. In block 327, the one or more downloaded files are parsed.

FIG. 5 shows details of block 327, in which the source code is parsed. In block 330 the next line (or first line) of the downloaded Web page source code is loaded into a memory or otherwise made ready for examination. In block 333 the line of source code is examined to determine if it contains an anchor tag. If it does contain an anchor tag, then in block 336 the link may be examined to determine it is a local link or a non-local link. If the link is a non-local link, in block 339 the URL of the link is extracted from the tag, and in block 342 identifying text is associated with the link (the bookmark). The URL and the associated identifying text may be stored in memory, and may be stored in a data files 212 for future reference. As discussed above, the identifying text associated with the link may be extracted from the anchor tag, may be the title of the Web page corresponding the URL, and/or may be all or part of the URL itself. In block 345, a determination is made as to whether there is more source code that needs to be parsed. If so, the parsing block 324 returns to block 330, to load the next line of source code. If not, the parsing block 324 ends.

Although the Web browser logic 206 and navigation logic 209 (FIG. 1) of the present invention is embodied in software or code executed by general purpose hardware as discussed above, as an alternative the Web browser logic 206 and navigation logic 209 may also be embodied in dedicated hardware or a combination of software/general purpose hardware and dedicated hardware. If embodied in dedicated hardware, the Web browser logic 206 and the navigation logic 209 (FIG. 1) can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, programmable gate arrays (PGA), field programmable gate arrays (FPGA), or other components, etc. Such technologies are generally well known by those skilled in the art and, consequently, are not described in detail herein.

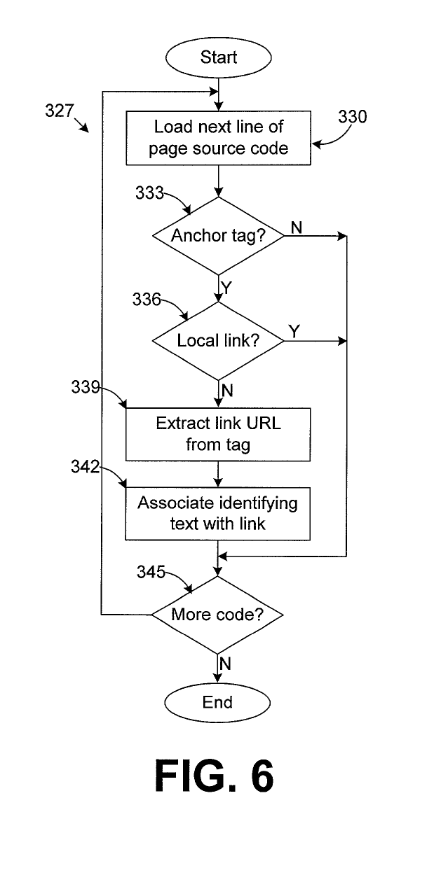

The flowcharts of FIGS. 4-6 show the architecture, functionality, and operation of an implementation of the Web browser/navigation logic 206/209 (FIGS. 4-6). If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor in a computer system or other system. The machine code may be converted from the source code, etc. If embodied in hardware, each block may represent a circuit or a number of interconnected circuits to implement the specified logical function(s).

Although the flowcharts of FIGS. 4-6 show a specific order of execution, it is understood that the order of execution may differ from that which is depicted. For example, the order of execution of two or more blocks may be scrambled relative to the order shown. Also, two or more blocks shown in succession in FIGS. 4-6 may be executed concurrently or with partial concurrence. In addition, any number of counters, state variables, warning semaphores, or messages might be added to the logical flow described herein, for purposes of enhanced usability, accounting, performance measurement, or providing troubleshooting aids, etc. It is understood that all such variations are within the scope of the present invention. Also, the flowcharts of FIGS. 4-6 are relatively self-explanatory and are understood by those with ordinary skill in the art to the extent that software and/or hardware can be created by one with ordinary skill in the art to carry out the various logical functions as described herein.

Also, where the Web browser logic 206 (FIG. 1) and/or the navigation logic 209 (FIG. 1) comprises software or code, it can be embodied in any computer-readable medium for use by or in connection with an instruction execution system such as, for example, a processor in a computer system or other system. In this sense, the logic may comprise, for example, statements including instructions and declarations that can be fetched from the computer-readable medium and executed by the instruction execution system. In the context of the present invention, a “computer-readable medium” can be any medium that can contain, store, or maintain the Web browser logic 206 and/or the navigation logic 179 for use by or in connection with the instruction execution system. The computer readable medium can comprise any one of many physical media such as, for example, electronic, magnetic, optical, electromagnetic, infrared, or semiconductor media. More specific examples of a suitable computer-readable medium would include, but are not limited to, magnetic tapes, magnetic floppy diskettes, magnetic hard drives, or compact discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A method of network navigation using a computer system, the method comprising:
displaying a group indicator associated with at least one bookmark group that includes a number of group-associated bookmarks that are maintained on a remote computer system;
accessing a locator for each of the group-associated bookmarks from the remote computer system, upon an occurrence of a selecting action directed at the group indicator; and
displaying a number of bookmark indicators, each of the bookmark indicators being associated with a respective one of the group-associated bookmarks.

2. The method of claim 1, wherein the accessing includes accessing the bookmark indicators from the remote computer system.

3. The method of claim 1, wherein the accessing includes downloading a web page from the remote computer.

4. The method of claim 3, wherein the accessing further includes parsing source code of the web page to extract the locators.

5. The method of claim 4, wherein the parsing includes extracting the bookmark indicators from the source code.

6. The method of claim 4, wherein the parsing includes examining the source code for anchor tags.

7. The method of claim 6, wherein the parsing includes examining the tags to determine whether links associated with the anchor tags are local links.

8. The method of claim 6, wherein the parsing includes extracting text from the anchor tags for the bookmark indicators.

9. The method of claim 1, wherein the selecting action includes clicking on the group indicator.

10. The method of claim 1, wherein the bookmark indicators are stored on the computer system, and wherein the displaying includes displaying the stored bookmark indicators.

11. The method of claim 10, wherein the stored bookmark indicators are updated by periodically performing the downloading and the determining.

12. The method of claim 1, wherein the accessing includes accessing at least one bookmark file on the remote computer.

13. The method of claim 12, wherein the at least one bookmark file include at least one file in a standard bookmark file format.

14. A computer program embodied in a computer readable medium, for network navigation, comprising:
code that displays a group indicator associated with at least one bookmark group that includes a number of group-associated bookmarks that are maintained on a remote computer system;
code that a locator for each of the group-associated bookmarks from the remote computer system, upon an occurrence of a selecting action directed at the group indicator; and
code that displays a number of bookmark indicators, each of the bookmark indicators being associated with a respective one of the group-associated bookmarks.

15. The computer program embodied in the computer readable medium of claim 14, wherein the code that accesses includes code that accesses the bookmark indicators from the remote computer system.

16. The computer program embodied in the computer readable medium of claim 14, wherein the code that accesses includes code that downloading a web page from the remote computer.

17. The computer program embodied in the computer readable medium of claim 16, wherein the code that accesses further includes code that parses source code of the web page to extract the locators.

18. The computer program embodied in the computer readable medium of claim 17, wherein the code that parses includes code that extracts the bookmark indicators from the source code.

19. The computer program embodied in the computer readable medium of claim 17, wherein the code that parses includes code that examines the source code for anchor tags.

20. The computer program embodied in the computer readable medium of claim 19, wherein the code that parses includes code that examines the tags to determine whether links associated with the anchor tags are local links.

21. The computer program embodied in the computer readable medium of claim 19, wherein the code that parses includes code that extracts text from the anchor tags for the bookmark indicators.

22. The computer program embodied in the computer readable medium of claim 14, wherein the code that accesses includes code that accesses the locators in response to a clicking on the group indicator.

23. The computer program embodied in the computer readable medium of claim 14, wherein the code that accesses includes code that accesses at least one bookmark file on the remote computer.

24. The computer program embodied in the computer readable medium of claim 23, wherein code that accesses the at least one bookmark file includes code that accesses at least one file in a standard bookmark file format.

25. A system for network navigation, comprising:
a processor coupled to a local interface;
a memory coupled to a local interface; and
processing logic stored on the memory and executable by the processor including:
logic that displays a group indicator associated with at least one bookmark group that includes a number of group-associated bookmarks that are maintained on a remote computer system;
logic that accesses a locator for each of the group-associated bookmarks from the remote computer system, upon an occurrence of a selecting action directed at the group indicator; and
logic that generates a display that includes a number of bookmark indicators, each of the bookmark indicators being associated with a respective one of the group-associated bookmarks.

26. A system for network navigation, comprising:
means for displaying a group indicator associated with at least one bookmark group that includes a number of group-associated bookmarks that are maintained on a remote computer system;
means for accessing a locator for each of the group-associated bookmarks from the remote computer system, upon an occurrence of a selecting action directed at the group indicator; and
means for displaying a number of bookmark indicators, each of the bookmark indicators being associated with a respective one of the group-associated bookmarks.

27. A method of network navigation using a computer system, the method comprising:
displaying a group indicator associated with at least one bookmark group that includes a number of group-associated bookmarks that are maintained on a remote computer system;
accessing a locator for each of the group-associated bookmarks from the remote computer system, upon an occurrence of a selecting action directed at the group indicator, wherein the accessing includes:
downloading a web page from the remote computer; and
parsing source code of the web page to extract the locators, wherein the parsing includes:
extracting the bookmark indicators from the source code;
examining the source code for anchor tags; and
extracting text from the anchor tags for the bookmark indicators; and
displaying a number of bookmark indicators, each of the bookmark indicators being associated with a respective one of the group-associated bookmarks.
